(19) United States
(12) Patent Application Publication
(10) Pub. No.: US 2009/0241616 A1
(43) Pub. Date: Oct. 1, 2009

(54) LOCKING DEVICE

(75) Inventor: Ying-Chih Tseng, Taipei (TW)

Correspondence Address: MECHPARTS GLOBAL SERVICES INC., P.O.BOX 108-00403, Taipei, 106, omitted

(73) Assignee: MECHPARTS GLOBAL SERVICES INC., Taipei Hsien (TW)

(21) Appl. No.: 12/057,389

(22) Filed: Mar. 28, 2008

(51) Int. Cl. E05B 13/10

(52) U.S. Cl. 70/224

(57) ABSTRACT

A locking device includes a barrel affixed to a plate member of a sliding track in a housing structure, a lock bolt movable in and out of the barrel for locking an external mobile device to the sliding track, a pull knob provided at the back side of the barrel and connected with the lock bolt for moving the lock bolt in and out of the barrel, and a spring mounted in the barrel to impart an outward pressure to the lock bolt and to hold the lock bolt in the locking position.

### BACKGROUND OF THE INVENTION

1. Field of the Invention

The present invention relates to locks for use in a computer, desk or cabinet to lock an external mobile device and more particularly, to a locking device that is easy to install and provides a high level of pull-out strength.

2. Description of the Related Art

To facilitate maintenance, test, device replacement or sharing of a common machine chassis, a machine chassis generally has a mount for receiving mobile electronic devices, for example, mobile measuring devices in an industrial instrument or mobile hard disk drives in an industrial computer. The mount of a machine chassis has sliding tracks. A mobile electronic device can be inserted in and out of one sliding track in the mount.

When a mobile electronic device is pulled out of the mount of a machine chassis, it can be connected to an external apparatus for use with the external apparatus. Because the width of the sliding tracks in the mount of a machine or computer system is slightly greater than the width of the mobile electronic devices to be received in the mount and because mobile electronic devices are frequently pulled out of and pushed into the mount, the loaded mobile electronic devices may be forced to vibrate in the mount accidentally after mounting. Screws may be used to lock mobile electronic devices to the mount. However, it is not practical to use screws for locking mobile electronic devices that are to be frequently removed from mount of the machine chassis for application. Lock pins may be used and detachably installed in the mount inside a machine chassis to lock mobile electronic devices. However, because lock pins are detachably installed in the mount, they will get lost easily. Further, when a user is using a lock pin, the sharp tip of the lock pin may injure the user accidentally.

### SUMMARY OF THE INVENTION

The present invention has been accomplished under the circumstances in view. It is therefore one object of the present invention to provide a locking device that eliminates the aforesaid problems.

According to one aspect of the present invention, the locking device comprises a barrel affixed to a plate member of a sliding track in a housing structure, a lock bolt movable in and out of the barrel for locking an external mobile device to the sliding track, a pull knob provided at the back side of the barrel and connected with the lock bolt for moving the lock bolt in and out of the barrel, and a spring mounted in the barrel to impart an outward pressure to the lock bolt and to hold the lock bolt in the locking position.

According to another aspect of the present invention, the barrel comprises a stop flange extending around the periphery of the front side thereof and stopped against the back side of the plate member, and a mounting flange forwardly extending from the front side of the stop flange and inserted through a mounting through hole on the plate member and riveted to the front side of the stop member to fixedly secure the barrel to the plate member against vibration.

### BRIEF DESCRIPTION OF THE DRAWINGS

FIG. 1 is an elevational view of a locking device in accordance with the present invention.

FIG. 2 is an exploded view of the locking device in accordance with the present invention.

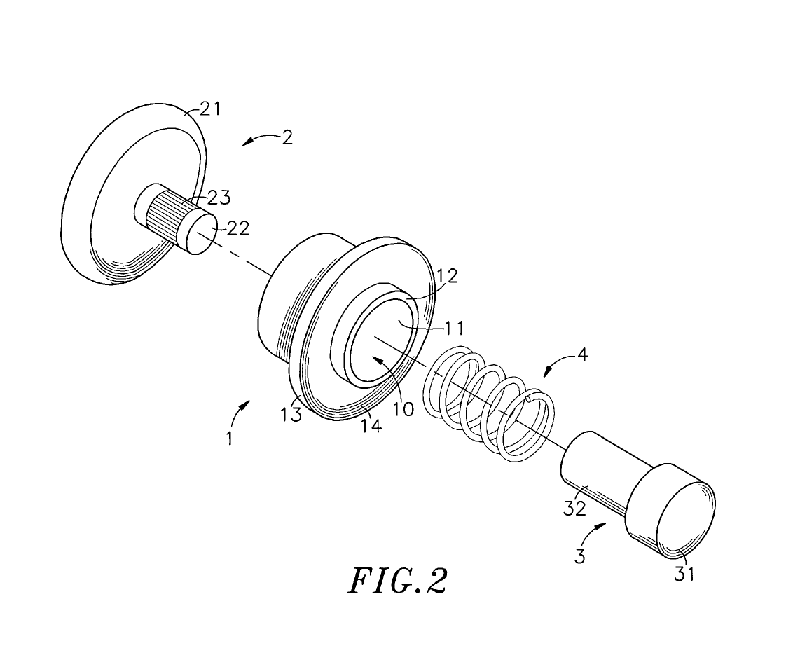

FIG. 3 is a sectional view of FIG. 2.

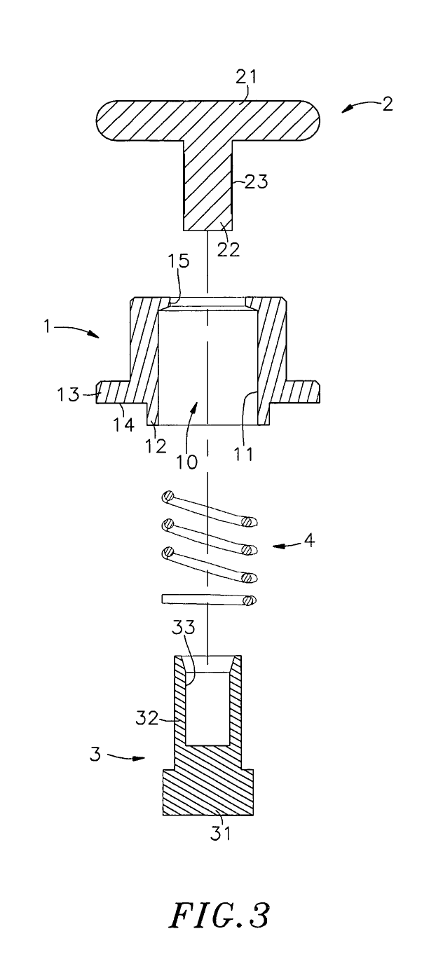

FIG. 4 is a sectional view of the present invention, showing the locking device in the locking position.

FIG. 5 is a sectional view of the present invention, showing the locking device in the unlocking position.

FIG. 6 is a schematic applied view of the present invention.

### DETAILED DESCRIPTION OF THE PREFERRED EMBODIMENT

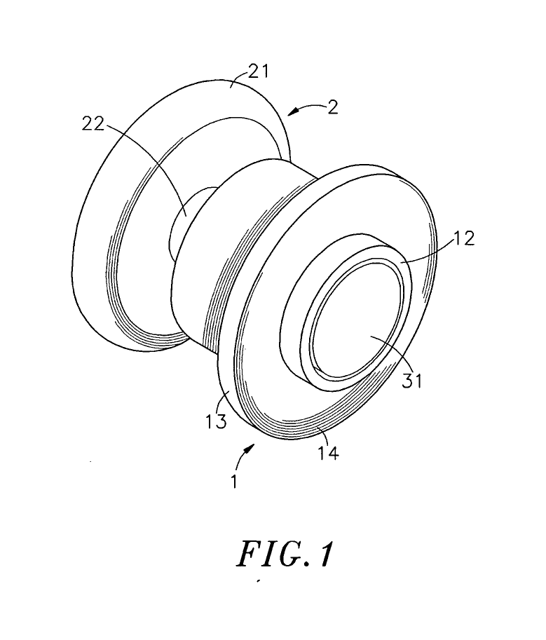

Referring to FIGS. 1˜4, a locking device in accordance with the present invention is shown comprised of a barrel 1, a pull knob 2, a lock bolt 3 and a spring 4.

The barrel 1 has an accommodation chamber 10, an opening 11 in communication with one side, namely, the front side of the accommodation chamber 10, an insertion hole 15 in communication with the other side, namely, the rear side of the accommodation chamber 10, a stop flange 13 radially extending around the periphery of the front side, and a mounting flange 12 axially forwardly protruded from a front wall 14 of the stop flange 13 around the opening 11.

The pull knob 2 has a head 21, a shank 22 perpendicularly extending from the center of one side of the head 21 and inserted through the insertion hole 15 into the inside of the accommodation chamber 10 of the barrel 1, and a plurality of raised portions 23. According to the present preferred embodiment, the raised portions 23 are raised lines spaced around the periphery of the shank 22 and extending along the length.

The lock bolt 3 has a locking portion 31 and a cylindrical coupling portion 32 extending from one side of the locking portion 31. The cylindrical coupling portion 32 defines a plughole 33 that extends axially from its distal end remote from the locking portion 31 in direction toward the locking portion 31.

During the assembly process of the present invention, the spring 4 is sleeved onto the cylindrical coupling portion 32 of the lock bolt 3, and then the spring 4 is inserted with the cylindrical coupling portion 32 of the lock bolt 3 through the opening 11 of the barrel 1 into the accommodation chamber 10, and then the shank 22 of the pull knob 2 is inserted through the insertion hole 15 of the barrel 1 into the plughole 33 of the cylindrical coupling portion 32 of the lock bolt 3 and processed by means of a processing tool to deform the inside wall of the cylindrical coupling portion 32 of the lock bolt 3 and to force the inside wall of the cylindrical coupling portion 32 of the lock bolt 3 into engagement with the raised portions 23 of the shank 22 of the pull knob 2 fixedly, keeping the two opposite ends of the spring 4 respectively stopped against the locking portion 31 of the lock bolt 3 and the inside wall of the accommodation chamber 10 of the barrel 1.

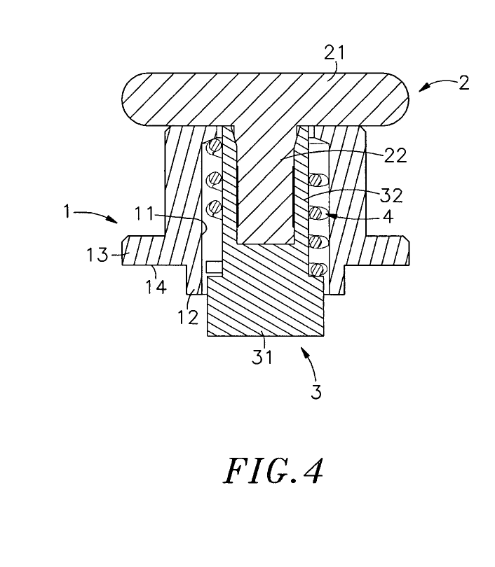

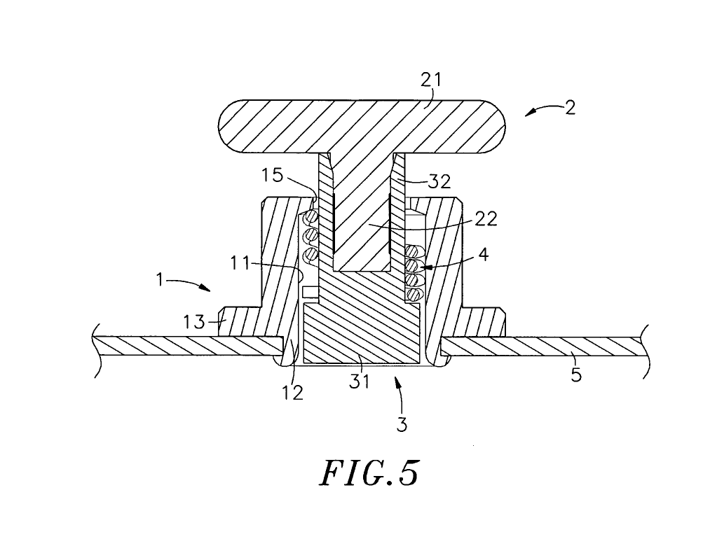

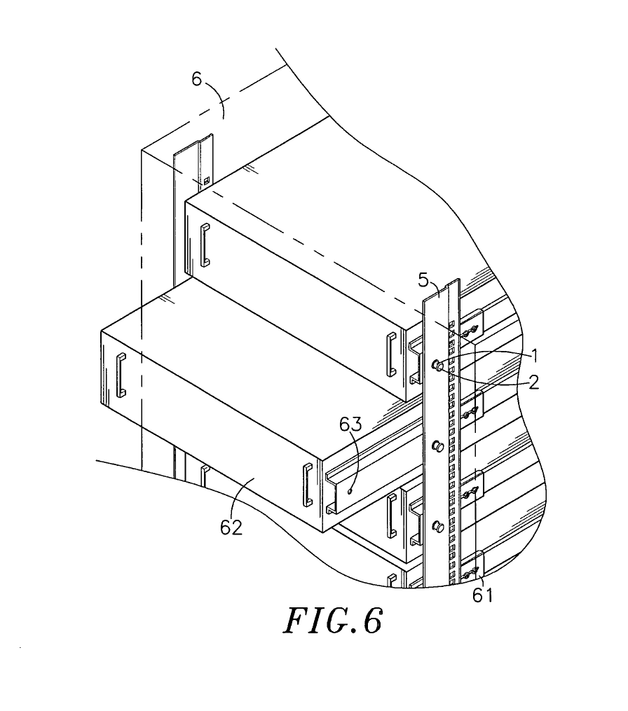

Referring to FIGS. 5 and 6 and FIG. 4 again, the locking device is installed in a plate member 5 by means of tightly fitting the mounting flange 12 of the barrel 1 into a mounting through hole (not shown) on the plate member 5 and stopping the front wall 14 of the stop flange 13 against one side of the plate member 5 then hammering down the end of the mounting flange 12 onto the other side of the plate member 5 to fixedly secure the barrel 1 to the plate member 5. The plate member 5 can be a part of a sliding track 61 in a computer housing 6. When inserting a mobile electronic device 62 into the sliding track 61, pull the head 21 of the pull knob 2 backwards to move the lock bolt 3 into the inside of the barrel 1 to simultaneously compress the spring 4. After the mobile electronic device 62 has been inserted into position, release the hand from the pull knob 2. At this time, the spring 4 returns the lock bolt 3 to its former position, engaging the locking portion 31 into a lock hole 63 at one side of the mobile electronic device 62 to lock the mobile electronic device 62 to the sliding track 61.

The locking device of the present invention is not limited to application for use in a computer. It can also be in a sliding track or groove inside a desk, cabinet, industrial computer, exchange machine, etc. to lock a mobile member.

In actual practice, the locking device of the present invention has the following features and advantages:

1. In order to reduce space occupation and to have the locking device be tightly attached to the surface of the plate member 5, the structure of the locking device must be small sized. The shank 22 of the pull knob 2 is made having raised portions 23. When the shank 22 is forced into the plughole 33 of the lock bolt 3, the raised portions 23 enhance engaging tightness between the shank 22 of the pull knob 2 and the cylindrical coupling portion 32 of the lock bolt 3. This engagement arrangement facilitates small size design of the locking device, providing a high level of binding of pull-out strength.

2. The radially extending stop flange 13 and the axially extending mounting flange 12 facilitates quick and positive installation of the locking device in the plate member 5. During installation, the radially extending stop flange 13 is stopped against one side of the plate member 5, and the axially extending mounting flange 12 is inserted through the plate member 5 and hammered down to form another head at the other side of the plate member 5 to fixedly secure the barrel 1 to the plate member 5 against vibration.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A locking device comprising:
a barrel, said barrel having an opening disposed at a front side thereof, an insertion hole disposed at a rear side thereof in axial alignment with said opening, an accommodation chamber in communication between said opening and said insertion hole, and a mounting flange forwardly extending from the front side around said opening for mounting;
a lock bolt inserted through said opening into said accommodation chamber and movable in and out of said barrel for locking an external mobile device, said lock bolt comprising a locking portion for engaging into a lock hole on the external mobile device to lock the external mobile device and a cylindrical coupling portion extending from said locking portion and inserted through said opening into said accommodation chamber, said cylindrical coupling portion defining a plughole;
a pull knob, said pull knob comprising a head suspending outside the rear side of said barrel and stoppable against the rear side of said barrel outside said insertion hole and a shank perpendicularly extending from said head and inserted into said insertion hole of said barrel and fixedly connected to said plughole of said cylindrical coupling portion of said lock bolt for enabling said lock bolt to be moved in and out of said barrel by said pull knob; and
a spring member sleeved onto said cylindrical coupling portion of said lock bolt and stopped between said locking portion of said lock bolt and an inside wall of said barrel to force said lock bolt out of said barrel.

2. The locking device as claimed in claim 1, wherein said shank of said pull knob comprises a plurality of raised lines spaced around the periphery thereof and tightly-fitted with said shank into said plughole of said cylindrical coupling portion of said lock bolt tightly.

3. The locking device as claimed in claim 1, wherein said mounting flange of said barrel is inserted into a mounting through hole of said plate member and riveted to a front side of said plate member.

4. The locking device as claimed in claim 3, wherein said barrel comprises a stop flange extending around the periphery of the front side thereof and stopped against a back side of said plate member opposite to the front side of said plate member.

5. A locking device mounted in a mounting through hole of a plate member of sliding track means in a housing structure for locking an external mobile device, said locking device comprising:
a barrel fastened to said plate member, said barrel having an opening disposed at a front side thereof, an insertion hole disposed at a rear side thereof in axial alignment with said opening, an accommodation chamber in communication between said opening and said insertion hole, a stop flange extending around the periphery of the front side of said barrel and stopped against a back side of said plate member, and a mounting flange forwardly extending from a front side of said stop flange and fastened to the mounting through hole of said plate member;
a lock bolt inserted through said opening into said accommodation chamber and movable in and out of said barrel for locking the external mobile device, said lock bolt comprising a locking portion for engaging into a lock hole on the external mobile device to lock the external mobile device and a cylindrical coupling portion extending from said locking portion and inserted through said opening into said accommodation chamber, said cylindrical coupling portion defining a plughole;
a pull knob, said pull knob comprising a head suspending outside the rear side of said barrel and stoppable against the rear side of said barrel outside said insertion hole and a shank perpendicularly extending from said head and inserted into said insertion hole of said barrel and fixedly connected to said plughole of said cylindrical coupling portion of said lock bolt for enabling said lock bolt to be moved in and out of said barrel by said pull knob; and
a spring member sleeved onto said cylindrical coupling portion of said lock bolt and stopped between said locking portion of said lock bolt and an inside wall of said barrel to force said lock bolt out of said barrel.

6. The locking device as claimed in claim 5, wherein said shank of said pull knob comprises a plurality of raised lines spaced around the periphery thereof and tightly-fitted with said shank into the plughole of said cylindrical coupling portion of said lock bolt tightly.

7. The locking device as claimed in claim 5, wherein said mounting flange of said barrel has a front side riveted to a front side of said plate member opposite to said stop flange at the back side of said plate member.
